(19) United States
(12) Patent Application Publication
(10) Pub. No.: US 2009/0153080 A1
(43) Pub. Date: Jun. 18, 2009

(54) AC power driving apparatus

(76) Inventor: Ching-Chung Lee, Rende Shiang (TW)

Correspondence Address: Frenkel & Associates, P.C., Suite 330, 3975 University Drive, Fairfax, VA, 22030, US

(21) Appl. No.: 12/002,715

(22) Filed: Dec. 18, 2007

(51) Int. Cl. H02P 5/00; H02P 1/58; H02P 5/60; H02J 7/14; B60L 11/18; H02K 53/00

(52) U.S. Cl. 318/49; 318/139; 320/137; 318/107; 415/916

(57) ABSTRACT

An AC power driving apparatus includes at least a DC input end, a DC motor, a plurality of AC output coils, a plurality of AC motors, a power chargeback device and a plurality of wires. The DC input end is connected to one side of the DC motor through the wires to supply driving power to the DC motor. The DC motor has another side connecting to one AC output coil through the wires to output AC power to one AC motor connected to another side of the AC output coil. The AC motor drives another AC output coil connected to one side thereof to generate amplification to be output. Thereby the another AC output coil is able to supply power to another AC motor to provide driving power.

### FIELD OF THE INVENTION

The present invention relates to an AC power driving apparatus and particularly to an apparatus to convert DC/AC and generate energy to provide driving power.

### BACKGROUND OF THE INVENTION

Conventional power driving generally adopts direct energy supply. Such an approach has shortcomings in practice, notably:

1. The conventional power driving usually adopts single type energy supply such as AC. If that type of power is in short supply use of power is constrained.

2. Shortage of energy resources increasingly becomes a serious problem in the world today. No mutual conversion among various types of energy creates great inconvenience to people's life.

### SUMMARY OF THE INVENTION

The primary object of the present invention is to provide an AC power driving apparatus to convert different types of energy to achieve more versatile utilization.

To achieve the foregoing object the AC power driving apparatus of the invention includes at least a DC input end, a DC motor, a plurality of AC output coils, a plurality of AC motors, a power chargeback device and a plurality of wires. The DC input end is connected to one side of the DC motor through the wires to supply driving power to the DC motor. The DC motor has another side connecting to one AC output coil through the wires to output AC power to one AC motor connected to another side of the AC output coil. The AC motor drives another AC output coil connected one side thereof to generate amplification to be output. Thereby the another AC output coil is able to supply power to another AC motor to supply driving power. The AC motor has a power chargeback device at another side thereof connected to the DC input end at another side of the power chargeback device to receive power for charging. Thus the DC input end can be used continuously without replacing.

The foregoing, as well as additional objects, features and advantages of the invention will be more readily apparent from the following detailed description, which proceeds with reference to the accompanying drawings. Various types of structures and embodiments may be adopted to implement the invention. One embodiment is discussed below. It serves only for illustrative purpose and is not the limitation of the invention.

### BRIEF DESCRIPTION OF THE DRAWINGS

FIG. 1 is a perspective view of the invention.

FIG. 2 is a perspective view of an embodiment of the invention.

FIG. 3 is a perspective view of the structure of an AC output coil of the invention.

FIG. 4 is a flowchart of the invention.

### DETAILED DESCRIPTION OF THE PREFERRED EMBODIMENT

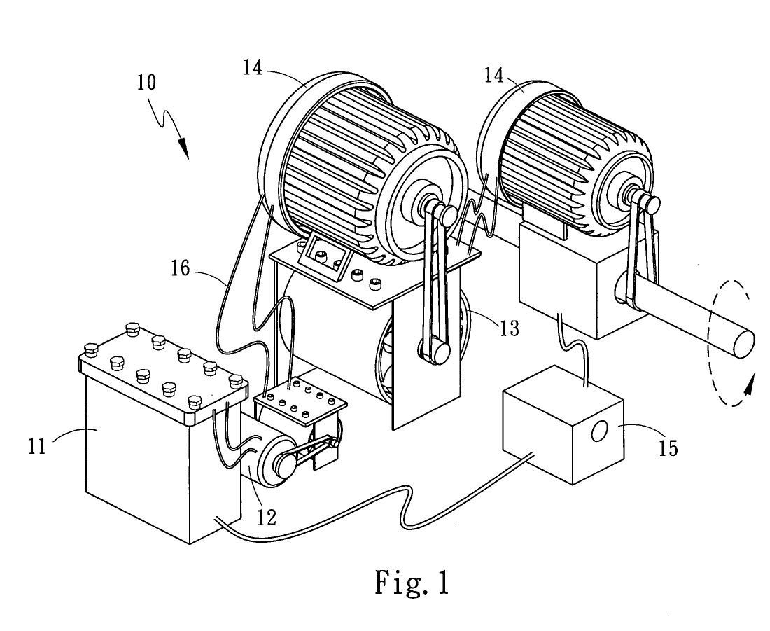

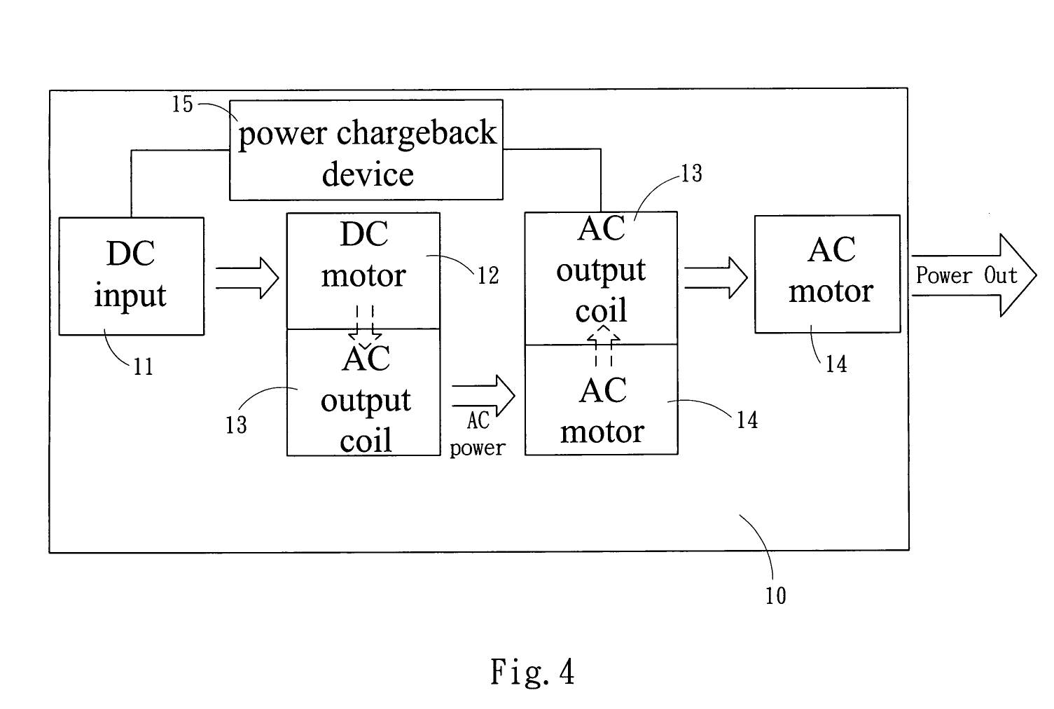

Please referring to FIGS. 1, 2 and 4, the AC power driving apparatus 10 according to the invention includes at least a DC input end 11, a DC motor 12, a plurality of AC output coils 13, a plurality of AC motors 14, a power chargeback device 15 and a plurality of wires 16. The DC input end 11 is connected to one side of the DC motor 12 through the wires 16 to supply driving power to the DC motor 12. The DC motor 12 has another side connecting to one AC output coil 13 through the wires 16 to output AC power to one AC motor 14 connected to another side of the AC output coil 13. The AC motor 14 drives another AC output coil 13 connected one side thereof to generate amplification to be output. Thereby the another AC output coil 13 is able to supply power to another AC motor 14 to supply driving power. The AC motor 14 has a power chargeback device 15 at another side thereof connected to the DC input end 11 at another side of the power chargeback device 15 to receive power for charging. Thus the DC input end 11 can be used continuously without replacing. The DC input end 11 may be a general equipment to output DC power, such as a general battery, storage battery, or the like. The wires 16 may be general flexible conductive wires such as ordinary electric wires, copper wires or the like.

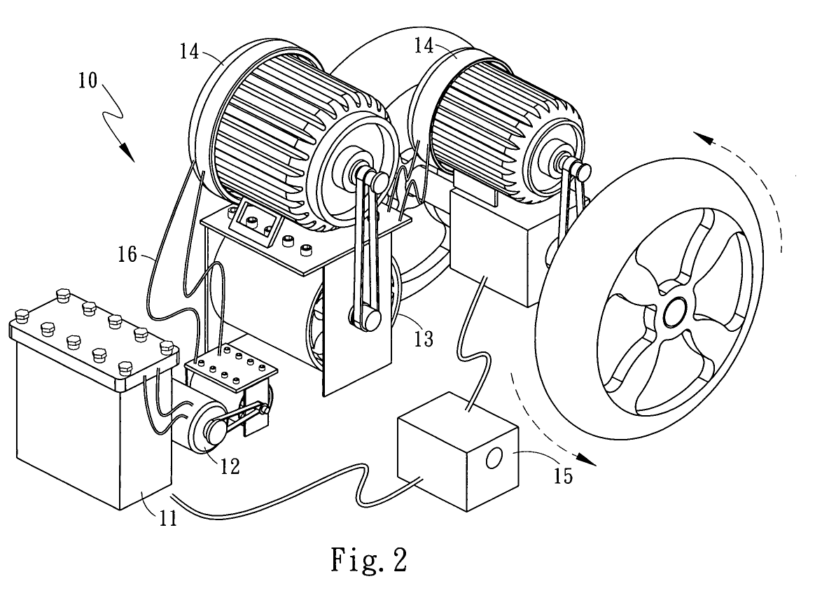

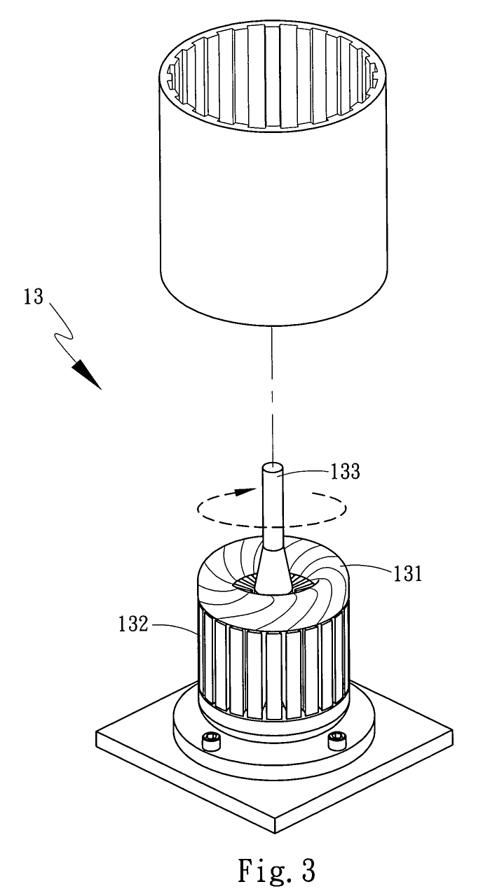

When the AC power driving apparatus 10 of the invention is in use, the DC input end 11 provides DC power to drive the DC motor 12; the DC motor 12 drives one AC output coil 13 to output AC power; the AC output coil 13 outputs AC power to drive one AC motor 14 which drives another AC motor 14 to provide rotational driving power. The driving power can be output to drive rotational devices such as tires and axles or the like to be used by moving tools such as motor vehicles, motorcycles, or the like. The AC power driving apparatus 10 of the invention may be expanded to multiple sets to increase driving power. Referring to FIG. 2, the AC motor 14 can drive the power chargeback device 15 to recharge the DC input end 11. The AC output coils 13 have a plurality of metal conductive wires 131, a plurality of power gates 132 and a spindle 133. The metal conductive wires 131 are wound on the power gates 132. The spindle 133 is held in the power gate 132. These two have magnetic repulsion between them to generate a magnetic field. Consequently the spindle 133 can be rotated to generate electric power. The diameter of the metal conductive wires 131 and the number of power gates 132 can be adjusted to control magnetic force intensity and the rotation speed of the spindle 133, as shown in FIG. 3.

The AC power driving apparatus 10 of the invention can provide many advantages as follow over the convention power driving equipments:

1. The conventional power driving usually adopts single type of energy supply such as AC power or the like. In the event that one type of energy is in short supply use is constrained. By contrast, the AC power driving apparatus of the invention receives general DC input. Coupled with the power chargeback device 15, required DC power can be charged back while the driving power is delivered. Thus energy can be provided and used continuously and perpetually. It is more convenient and environmental friendly.

2. As short supply of energy resources becomes a serious problem these days, if various types of energy cannot be converted and interchanged people's life will be greatly affected. The AC power driving apparatus 10 of the invention can receive DC input, and after multiple amplifications through the AC coils, output of the driving power increases. It also can substitute the traditional energy without increasing environmental burden. It is a clean and green energy.

What is claimed is:

1. An AC power driving apparatus, comprising at least a DC input end, a DC motor, a plurality of AC output coils, a plurality of AC motors and a plurality of wires, wherein:
the DC input end is connected to one side of the DC motor through the wires to supply DC power to the DC motor, the DC motor having another side connecting to one AC output coil to output AC power to one AC motor connected to another side of the AC output coil, the AC motor driving another AC output coil connected to one side of the AC motor to amplify output so that the another AC output coil provides power to another AC motor to supply driving power.

2. The AC power driving apparatus of claim 1, wherein the AC output coils consist of a plurality of metal conductive wires, a plurality of power gates and a spindle, the metal conductive wires being wound on the power gates which hold the spindle.

3. The AC power driving apparatus of claim 1, wherein the AC motor has a power chargeback device located at another side thereof, the power chargeback device being connected to the DC input end at another side thereof to perform charging.

4. The AC power driving apparatus of claim 1, wherein the AC power driving apparatus is expandable to multiple sets according to power utilization requirements.

5. The AC power driving apparatus of claim 1, wherein the AC motors output power to drive motor vehicles.

6. The AC power driving apparatus of claim 1, wherein the AC motors output power to drive motorcycles.

7. The AC power driving apparatus of claim 1, wherein the DC input end is a general battery.

8. The AC power driving apparatus of claim 1, wherein the DC input end is a storage battery.

9. The AC power driving apparatus of claim 1, wherein the DC input end is an equipment to output DC electricity.

10. The AC power driving apparatus of claim 1, wherein the wires are electric conductive wires.

11. The AC power driving apparatus of claim 1, wherein the wires are copper wires.

12. The AC power driving apparatus of claim 1, wherein the wires are electric conductive flexible wires.

13. The AC power driving apparatus of claim 2, wherein the metal conductive wires are formed at a diameter which can be increased and decreased according to requirements.

14. The AC power driving apparatus of claim 2, wherein the number of the power gates can be increased and decreased according to requirements.
